(19) United States
(12) Patent Application Publication
(10) Pub. No.: US 2016/0288263 A1
(43) Pub. Date: Oct. 6, 2016

(54) OSCILLATING WELDING METHOD

(71) Applicants: Siemens Aktiengesellschaft, München (DE); Fraunhofer Gesesschaft zur Förderung der angewandt Forschung e.V., München (DE)

(72) Inventors: Nikolai ARJAKINE, Berlin (DE); Bernd BURBAUM, Falkensee (DE); Andres GASSER, Aachen (DE); Chen HONG, Aachen (DE); Stefanie LINNENBRINK, Kreuzau (DE); Frank MENTZEL, Aachen (DE); Michael OTT, Mülheim an der Ruhr (DE); Sebastian PIEGERT, Lübbenau (DE); Norbert PIRCH, Aachen (DE)

(21) Appl. No.: 15/037,826

(22) PCT Filed: Oct. 13, 2014
(86) PCT No.: PCT/EP2014/071904

§ 371 Date: May 19, 2016

(30) Foreign Application Priority Data
Dec. 10, 2013 (DE) 10 2013 225 490.3

(51) Int. Cl. B23K 26/34; B23K 26/00; F01D 5/14; B23K 26/144

(52) U.S. Cl. CPC B23K 26/34; B23K 26/144; B23K 26/0006; F01D 5/147; B23K 2201/001

(57) ABSTRACT

An oscillating welding method is provided. The oscillating movement during welding in the vertical and/or horizontal direction results in smaller grains being obtained, the smaller grains preventing the development of cracks during welding.

### CROSS-REFERENCE TO RELATED APPLICATIONS

This application claims priority to PCT Application No. PCT/EP2014/071904, having a filing date of Oct. 13, 2014, based off of German application No. 102013225490.3 having a filing date of Dec. 10, 2013, the entire contents of which are hereby incorporated by reference.

### FIELD OF TECHNOLOGY

The following relates to a welding method in which the welding beam is moved in oscillation.

### BACKGROUND

During laser deposition welding of nickel-based superalloys having a high fraction of metallic phase γ′, hot cracks can form during solidification of the melt. Reducing the beam diameter of the laser with circular intensity distribution raises the cooling rate and makes it possible to avoid solidification cracks. However, this reduces the rate of deposition of the material.

### SUMMARY

An aspect relates to specifying a welding method by means of which it is simultaneously possible to achieve high cooling rates and high deposition rates.

The method generates, simply and more rapidly, crack-free microstructures during welding.

### BRIEF DESCRIPTION

Some of the embodiments will be described in detail, with reference to the following FIGURES, wherein like designations denote like members, wherein:

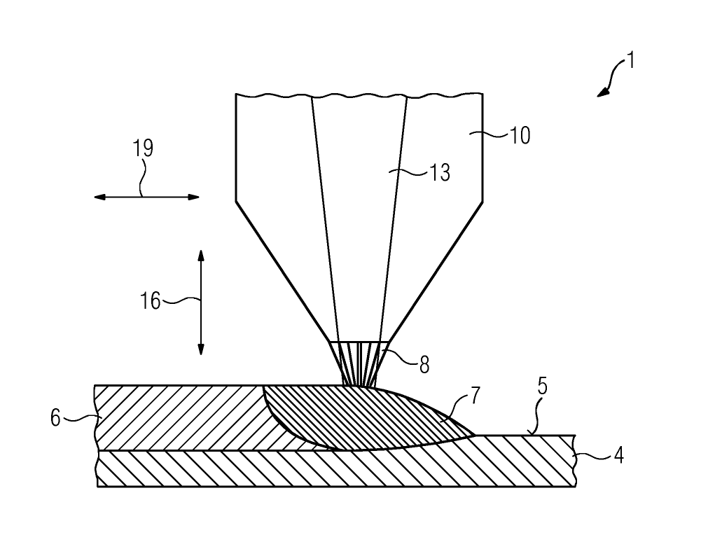

FIG. 1 shows, schematically, the arrangement of an embodiment of a deposition welding setup with a laser and a powder feed.

The FIGURE and the description represent only exemplary embodiments of the invention.

### DETAILED DESCRIPTION

An oscillating motion in the horizontal and/or vertical direction, and in the variation of the laser radiation, causes the solidification front to change constantly so as to produce an oscillating solidification form. A constantly changing solidification function interrupts grain growth during solidification of the melt and the lattice solidifies as a single grain. The fine-grained quality of the lattice causes the resulting remaining welding residual stresses to be distributed over the grain boundaries so as to avoid cracks in the welding seam or in the welding bead or therebetween.

The welding method can be remelt welding or deposition welding. Both methods produce a melt and a solidification front.

FIG. 1 shows a device 1 for a welding method, in particular a laser welding method.

The method is not restricted to laser welding methods, but is also applicable to electron beam welding methods and other welding methods such as plasma welding methods or also other additive production methods.

Material is deposited onto a substrate 4 which, in the case of turbine blades, is a nickel- or cobalt-based superalloy having a high γ′ fraction and is therefore an alloy having generally poor weldability. A welding bead 6, as part of the deposition weld, has already been generated.

At those points where a laser with its laser radiation as exemplary energy source 13 is oriented onto the substrate 4, there is a melt pool 7. Via a powder nozzle as exemplary material feed 10, the powder 8 is molten.

This laser radiation is in particular pulsed and the material 8 is supplied in the form of powder, but can also be supplied as a wire.

The laser radiation or the energy supply 13 can be moved back and forth along the direction 16 that is vertical with respect to the surface 5 of the substrate 4, so as to vary the laser beam diameter at the surface of the welding track 7. The deflection is preferably between 1 mm and 2 mm.

It is alternatively or additionally possible to carry out an oscillating motion perpendicular to the direction 16, preferably in the form of a horizontal motion 19 that is transverse to the forward motion of the energy supply 13 of the laser radiation and the powder feed 10 relative to the melt pool 7. The deflection of the oscillating motion is preferably between 1 mm and 2 mm.

The area to be welded has, in at least one direction, a length greater than or equal to 4 mm, i.e. preferably multiple welding beads are generated or deposited next to one another and may also overlap.

The vertical 16 and/or horizontal 19 motion can be used individually or combined with one another, both in remelting and deposition welding, and is superimposed over the forward motion of the energy supply 13 with respect to the substrate 4.

There results, in the case of an oscillating motion in the direction 19, a zigzag motion, a meandering motion or a sinusoidal motion as seen in the direction 16 in plan view onto the substrate 4. The same holds for a view perpendicular to the direction 16 in the case of an oscillating motion in the direction 16.

On the basis of embodiments of the invention, this procedure achieves improved material properties.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A welding method comprising:
moving an energy source for welding and/or a material feed so as to oscillate with respect to a surface of a substrate.

2. The method as claimed in claim 1, wherein remelt welding takes place.

3. The method as claimed in claim 1, wherein deposition welding takes place.

4. The method as claimed in claim 1, wherein the energy source is moved so as to oscillate in a vertical direction with respect to the surface.

5. The method as claimed in claim 1, wherein the energy source is moved so as to oscillate in a horizontal direction with respect to the surface.

6. The method as claimed in claim 1, wherein the energy source and the material feed are moved so as to oscillate horizontally with respect to the surface of the substrate.

7. The method as claimed in claim 1, wherein an oscillating motion in a vertical direction of the energy source and the material feed takes place.

8. The method as claimed in claim 1, wherein laser radiation is used as the energy source.

9. The method as claimed in claim 1, wherein a powder is used as a material, which is fed through the material feed.

10. The method as claimed in claim 1, wherein nickel- or cobalt-based superalloys are used as the substrate.

11. The method as claimed in claim 1, wherein a welding nozzle is used, the welding nozzle having the material feed and generation and supply of energy.

12. The method as claimed in claim 1, wherein the oscillating motion is up to 2 mm.

13. The method as claimed in claim 1, wherein a welded area is greater than or equal to 4 mm in at least one orientation.

14. The method as claimed in claim 1, wherein a plurality of welding beads are generated or deposited next to one another.

15. The method as claimed in claim 1, wherein the material feed is a powder feed, and the energy source is laser radiation.

16. The method as claimed in claim 12, wherein the oscillating motion has a deflection between 1 mm and 2 mm.
